(19) United States
(12) Patent Application Publication
(10) Pub. No.: US 2026/0119971 A1
(43) Pub. Date: Apr. 30, 2026

(54) SELECTING WEIGHTS FOR A MACHINE LEARNING MODEL BASED ON AN INPUT TO THE MACHINE LEARNING MODEL

(71) Applicant: Intuit Inc., Mountain View, CA (US)

(72) Inventors: Itay MARGOLIN, Petach Tikva (IL); Ido FARHI, Herzliya (IL); Eilon SHITRIT, Tel-Aviv (IL)

(21) Appl. No.: 18/931,897

(22) Filed: Oct. 30, 2024

(51) Int. Cl. G06N 20/00

(52) U.S. Cl. CPC G06N 20/00

(57) ABSTRACT

Certain aspects of the disclosure provide a computer-implemented method for varying machine learning model output. The method includes receiving an input for a machine learning model system; selecting, based on one or more parameters associated with the input, a set of weights of a plurality of sets of weights; providing the input to a machine learning model associated with the set of weights; and obtaining output from the machine learning model based on the input.

### BACKGROUND

### Field

Aspects of the present disclosure relate to varying machine learning model output.

### Description of Related Art

Machine learning (ML) models, e.g., large language models (LLMs) or neural networks, may be configured, such as trained, to process an input, such as audio, an image, video, code, music, design, text, or the like, and generate an output based on the input. For example, a machine learning model may be configured to recognize patterns in the input for the purpose of predicting a proper output response. In an example, an LLM may be implemented to perform a natural language processing (NLP) task, such as generating text as output that is responsive to a text prompt as input.

One vector of attacking a machine learning model may be to query the machine learning model a number of times, e.g., with brute-force trial and error methodology, and use the responses that may be received from the multitude of queries to gain an understanding of how the machine learning model works, e.g., the reasoning of the model, such as how the machine learning model was trained. In some cases, weaknesses of the machine learning model may be revealed to an attacker and further attacks may be customized to the weaknesses of the machine learning model.

As a result, the predictability in an output response of a machine learning model to a certain input may also represent a vulnerability to potential attacks, and thus a reduced level of predictability in an output response of the machine learning model may more effectively conceal the reasoning and training of the machine learning model.

A common method in the LLM context to reduce the level of predictability is to directly control a probability distribution of possible outputs generated by the model in response to a given input through the concept of temperature. For example, an LLM may generate a set of possible output responses to a given input and may assign probabilities to each possible output in the generated set, where one possible output may have a higher probability of being correct and another possible output may have a lower probability. There may be many possible outputs in the set, with the probability distributed among all the members of the set. In this context, a non-uniform distribution among possible output responses may lead to the model being more predictable or deterministic, while a more even distribution may lead to a wider range of possible outputs and thus reduced predictability.

The temperature parameter in the LLM context may be adjusted to separately apply a weight to each possible output response in the set, such that a lower temperature may apply less weight to the individual members of the set, causing the machine learning model to rely more on its training, while a higher temperature may cause the distribution to even out by applying more weight to the lower-probability outputs. However, although adjustments of temperature in the LLM context may reduce the predictability, and thus the vulnerability, of the model, there is a risk of nonsensical, or lower-quality, outputs from the machine learning model since a more even distribution among potential output responses also could lead to more incorrect responses.

As a result, there is a need for techniques that may reduce the level of predictability in an output response of a machine learning model to a certain input, which may more effectively conceal the reasoning and training of the machine learning model, such as without compromising the quality of the machine learning model output that may be returned for the input.

### SUMMARY

Certain aspects provide a computer-implemented method for varying machine learning model output. The method includes receiving an input for a machine learning model system; selecting, based on one or more parameters associated with the input, a set of weights of a plurality of sets of weights; providing the input to a machine learning model associated with the set of weights; and obtaining output from the machine learning model based on the input.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIGS. 1A-1C depict example machine learning model systems configured to select a set of weights for a machine learning model.

FIG. 2 depicts an example process for forming a machine learning model from an adaptor and a backbone machine learning model.

FIG. 3 depicts an example process for varying machine learning model system output.

FIG. 4 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for varying machine learning model parameters (e.g., weights) used for a machine learning model system based on parameters of an input to the machine learning model system.

As discussed, machine learning models are susceptible to various types of attacks, including an attacker attempting to understand how the machine model works based on correlations between multiple inputs to the machine learning model and multiple outputs of the machine learning model. One solution to such a problem is to vary the output of the machine learning model for a given input by adjusting a temperature of the machine learning model, so as to reduce the predictability of the output of the machine learning model. However, adjusting the temperature of the machine learning model to vary the output may reduce the quality of the output of the machine learning model. Accordingly, there exists a technical problem with respect to reducing the predictability of the output of a machine learning model, while not reducing the quality of the output of the machine learning model.

Certain aspects herein provide a technical solution to the technical problem of reducing the predictability in the output response of a machine learning model, without necessarily reducing the quality of the output, such as by providing techniques to vary machine learning model parameters (e.g., weights) used for a machine learning model system based on parameters associated with an input (also referred to as parameters of the input) to the machine learning model system. The parameters of the input may include contextual information associated with the input that may be variable, such as a time the input is received, an identifier of a source of the input (e.g., an Internet protocol (IP) address), or the like. Accordingly, even if the same input is received at different times, or from different sources, the parameters of the input may vary. As the machine learning model parameters may be selected based on the parameters of the input, the machine learning model parameters may also vary for different input. The configuration of the machine learning model system used to process the input may be based on the machine learning model parameters, as further discussed herein. Accordingly, even for the same input associated with different parameters of the input, the configuration of the machine learning model system used to process the input may vary, thereby varying the output generated by the machine learning model system. Accordingly, certain aspects discussed herein provide the technical benefit of varying the output generated by the machine learning model system, which may reduce predictability in the output response of the machine learning model system, providing a security benefit to the machine learning model system.

In certain aspects, a technique to vary machine learning model parameters used for a machine learning model system based on parameter(s) associated with an input to the machine learning model system includes selecting, based on parameter(s) of the input, a set of machine learning model parameters, such as a set of weights. Though certain aspects are discussed with respect to a set of weights as example machine learning model parameters, it should be understood that other machine learning model parameters may be used. In certain aspects, the set of weights may be selected from a plurality of sets of weights, which may correspond to different trained versions of a machine learning model.

In certain aspects, the machine learning model system includes a single machine learning model, such as a single instance of a machine learning model, and the selected set of weights are used to configure the machine learning model. The machine learning model system may then provide the input to the machine learning model configured with the selected set of weights. As different sets of weights may be selected for different inputs, the configuration of the machine learning model used for different inputs may change, thereby varying the output of the machine learning model system. In certain aspects, the different sets of weights may be generated based on training the machine learning model (or certain portion(s) of the machine learning model) multiple different times, such as with different training sets, for different number of iterations, or the like. Accordingly, in certain aspects, a machine learning model being “associated with a set of weights” may refer to configuring the machine learning model with the set of weights, and selecting the set of weights may refer to actually selecting a set of weights used to configure the machine learning model.

In certain aspects, the machine learning model system includes multiple machine learning models, such as multiple instances of a machine learning model. In some cases, each instance of the machine learning model may be trained to have a different set of weights, but may share the same underlying architecture. In some cases, the multiple machine learning models include multiple different machine learning models that may have variations in architecture. In certain aspects, the multiple machine learning models may be trained to have different sets of weights, such as through training using different training sets, for different number of iterations, or the like. In certain aspects, the machine learning model system may provide the input to the machine learning model associated with the selected set of weights. As different sets of weights may be selected for different inputs, the machine learning model used for different inputs may change, thereby varying the output of the machine learning model system. Accordingly, in some aspects, a machine learning model being “associated with a set of weights” may refer to the machine learning model being trained to have the set of weights. Further, in certain aspects, selecting the set of weights may refer to selecting the set of weights and mapping such set of weights to the machine learning model associated with the set of weights, or may refer to directly selecting a machine learning model associated with the set of weights, such as based on the parameters of the input.

In certain aspects, the machine learning model system includes a “backbone” model along with multiple different adaptors, e.g., with Low-Rank Adaptation (LoRA) as discussed further herein. For example, a backbone model may not be a full machine learning model, but rather may only correspond to a portion of a machine learning model, such as a certain number of layers of the overall layers of a machine learning model. An adaptor may be combined with the backbone model, to form a full machine learning model. For example, an adaptor may correspond to the remaining layers of the overall layers of the machine learning model that are not included in the backbone model. In certain aspects, the weights of the backbone model may not change based on the parameters of the input to the machine learning model system. However, there may be multiple different adaptors trained to have different sets of weights, such as through training using different training sets, for different number of iterations, or the like.

In certain aspects, the machine learning model system may form the machine learning model from the adaptor associated with the selected set of weights and the backbone model. The machine learning model system may then provide the input to the machine learning model. As different sets of weights may be selected for different inputs, the machine learning model used for different inputs may change based on the changed adaptor, thereby varying the output of the machine learning model system. Accordingly, in some aspects, a machine learning model being “associated with a set of weights” may refer to the machine learning model being based on an adaptor having the set of weights. Further, in certain aspects, selecting the set of weights may refer to selecting the set of weights and mapping such set of weights to the adaptor associated with the set of weights, or may refer to directly selecting an adaptor associated with the set of weights, such as based on the parameters of the input.

In certain aspects, the machine learning model system may be configured to vary the output of the machine learning model system, such as by selecting a set of weights based on parameter(s) of the input, based on determining the input poses a security risk. For example, if the same input is received multiple times, or many inputs are received from a same source within a short time window, the machine learning model system may determine that an attacker is trying to attack the machine learning model system. In certain aspects, only enabling the varying of the output of the machine learning model system when a potential security risk is determined may reduce computational complexity for more benign inputs, providing the technical benefit of improved compute performance. In certain aspects, only enabling the varying of the output of the machine learning model system when a potential security risk is determined may further reduce output variation for legitimate inputs, providing the technical benefit of potentially more accurate output.

### Example Machine Learning Model System

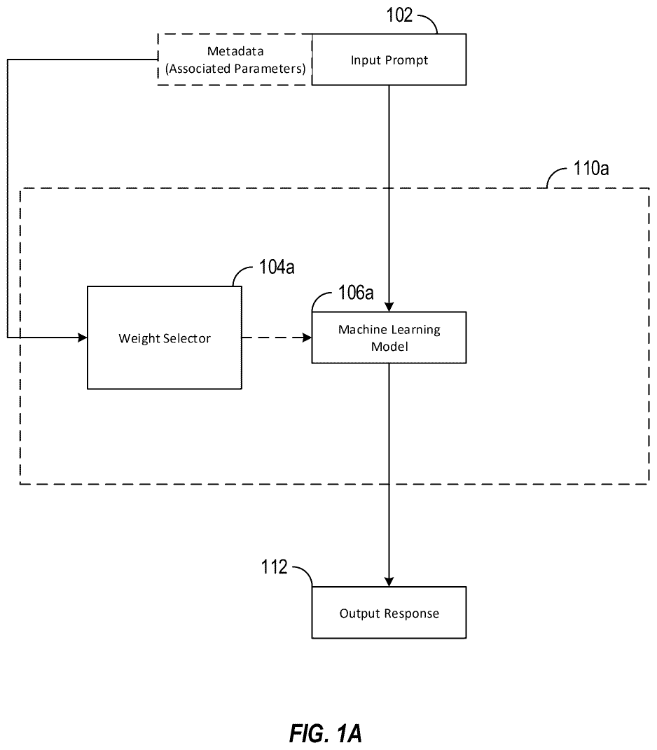

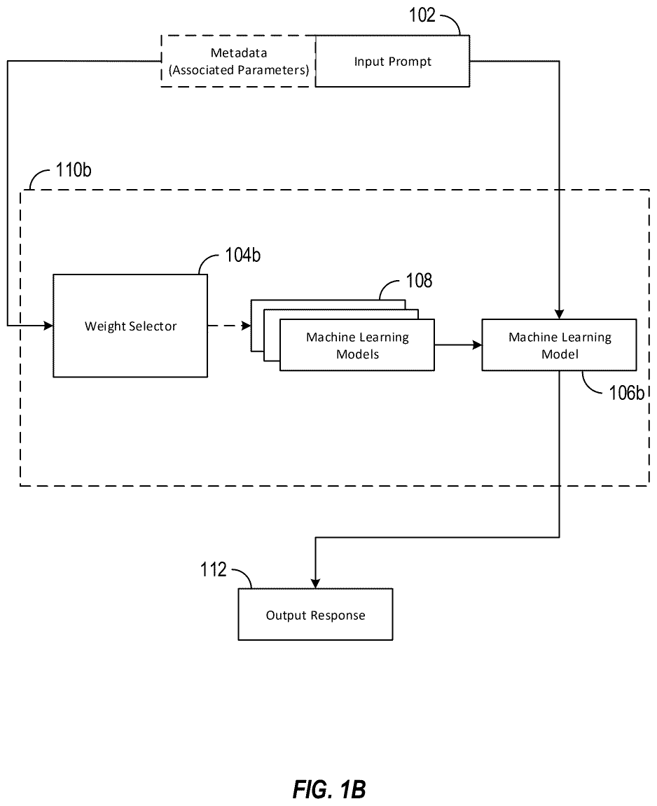

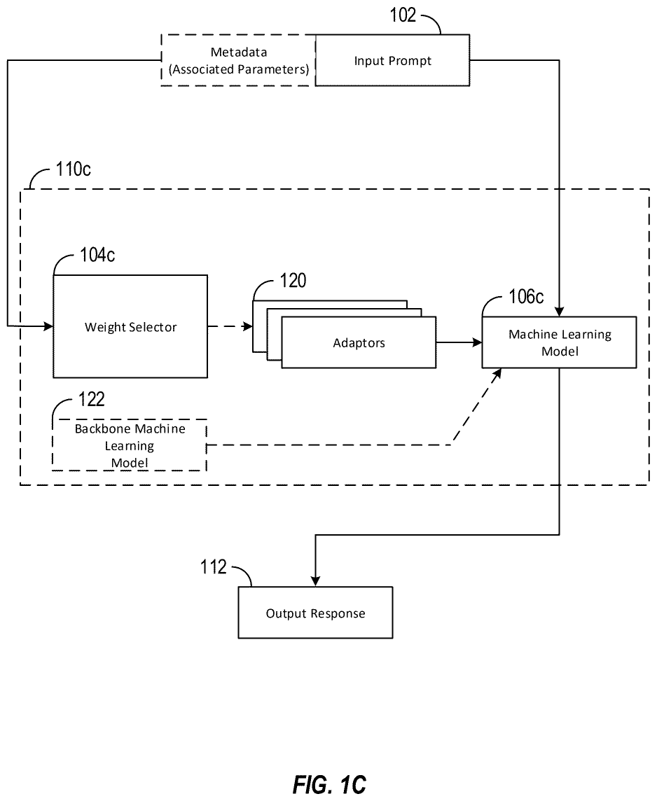

FIGS. 1A-1C depict different examples of a machine learning model system 110 (shown as example machine learning model systems 110a-110c, wherein common characteristics between the examples are discussed with respect to “machine learning model system 110”) configured to select a set of weights for a machine learning model.

In certain aspects, machine learning model system 110 is configured to take an input (e.g., multimodal or unimodal), provide the input to a machine learning model, and obtain output (e.g., multimodal or unimodal) from the machine learning model based on the input. For example, the input and/or output may include audio, an image, video, code, music, design, text, or the like. In some aspects, the machine learning model may be an LLM.

In certain aspects, machine learning model system 110, as discussed, is configured to vary machine learning model parameters (e.g., weights) used for a machine learning model based on parameters associated with the input to the machine learning model system 110.

For example, as shown in the example of FIG. 1A, machine learning model system 110a may include a weight selector 104a and a machine learning model 106a. In particular, machine learning model system 110a may include a single machine learning model 106a. In certain aspects, the weight selector 104a is configured to select a set of weights for the machine learning model 106a. The weight selector 104a may configure the machine learning model 106a with the selected set of weights, such that the machine learning model 106a operates based on the selected set of weights. The machine learning model system 110a may provide an input prompt 102 to the configured machine learning model 106a, which is configured to provide an output response 112 in response to the input prompt 102.

In certain aspects, the weight selector 104a is configured to select the set of weights from a plurality of sets of weights. For example, the plurality of sets of weights may be different learned sets of weights for the machine learning model 106a that may be prior determined as part of a training process for the machine learning model 106a.

In particular, as part of a training process, the machine learning model 106a may learn a set of weights, which may be numerical values that represent the strength and direction of the connection between neurons in a neural network forming the machine learning model 106a. The machine learning model 106a may be trained, for example, using training data to tune the weights of the machine learning model 106a. For example, backpropagation techniques may be used to train the machine learning model 106a by iteratively adjusting weights of certain artificial neurons associated with errors between a predicted output of the model and a desired output that may be known or otherwise deemed acceptable.

In certain aspects, the machine learning model 106a may be trained multiple different times in order to generate multiple different sets of weights corresponding to the plurality of sets of weights. For example, different sets of weights may be determined based on using one or more of different training data for training, performing a different number of iterations for training, or the like. In certain aspects, the plurality of sets of weights may be stored in a storage accessible by weight selector 104a.

In certain aspects, weight selector 104a is configured to select the set of weights from the plurality of sets of weights based on the input prompt 102 to be provided to machine learning model 106a. For example, weight selector 104a may be configured to select the set of weights from the plurality of sets of weights based on parameters of prompt 102, as discussed. The parameters of the input prompt 102 may include contextual information associated with the input that may be variable, such as a time the input is received, an identifier of a source of the input (e.g., IP address), or the like.

In certain aspects, the weight selector 104a is configured to “map” one or more parameters of the input prompt 102 to a set of weights of the plurality of weights. As an example, each of the sets of weights of the plurality of weights may be associated with an index value, such as a first set of weights associated with index 1, a second set of weights associated with index 2, etc.

The weight selector 104a may further be configured to determine an index value based on one or more parameters of the input prompt 102, such as based on a hash value of the one or more parameters of the input prompt 102. For example, the one or more parameters of the input prompt 102 may include a timestamp associated with the input prompt 102, such as when the input prompt 102 is received at machine learning model system 110a, and an IP address of a source of the input prompt 102. The weight selector 104a may concatenate the timestamp and IP address to generate a concatenated value. The weight selector 104a may apply a hash function to the concatenated value, such as to get an integer result. The weight selector 104a may further perform a modulo operation on the integer result, such as K=integer result % T, where T is the number of sets of weights of the plurality of sets of weights. Accordingly, the weight selector 104a may generate an index value K, that is from 1 to T. The weight selector 104a may therefore select the set of weights associated with index value K.

Accordingly, in certain aspects, weight selector 104a is configured to vary the weights of machine learning model 106a based on parameters of an input to machine learning model 106a, which may reduce predictability of output of machine learning model 106a, which may provide the technical benefit of added security for machine learning model 106a. In particular, if a first input is received with a first prompt, such as a first text string, and the first input is associated with a first set of parameters, the machine learning model 106a may have a first output. Further, if a second input is received with the same first prompt, but the second input is associated with a second set of parameters different than the first set of parameters, the machine learning model 106a may have a second output different than the first output. Therefore, even with the same prompt, the output of the machine learning model 106a may differ, making the output less predictable.

FIG. 1B illustrates an example machine learning model system 110b similar to machine learning model system 110a. For example, the machine learning model system 110b may provide an input prompt 102 to the configured machine learning model 106b, which is configured to provide an output response 112 in response to the input prompt 102. However, in certain aspects, instead of weight selector 104b configuring a machine learning model 106b with a selected set of weights such as in FIG. 1A, weight selector 104b is configured to select the machine learning model 106b associated with the selected set of weights from among a plurality of machine learning models 108.

In particular, each of the plurality of machine learning models 108 may be associated with a respective set of weights of the plurality of sets of weights. For example, in certain aspects, each of the plurality of machine learning models 108 may be of a same machine learning model architecture, but trained differently such as discussed with respect to FIG. 1A, such that it is configured with a different set of weights. In some aspects, different machine learning models 108 may have different architectures such that they are configured with a different set of weights.

In certain aspects, weight selector 104b is configured to select the set of weights based on one or more parameters of input prompt 102, such as described with respect to FIG. 1A. Further, weight selector 104b may be configured to map the selected set of weights to the machine learning model 106b, of the plurality of machine learning models 108, that is associated with the selected set of weights. Accordingly, weight selector 104b is configured to select the machine learning model 106b.

In certain aspects, the weight selector 104b is configured to map one or more parameters of the input prompt 102 to a model of the plurality of machine learning models 108. As an example, each of the plurality of machine learning models 108 associated with the plurality of sets of weights may be associated with an index value, such as a first machine learning model associated with index 1, a second machine learning model associated with index 2, etc. The weight selector 104b may further be configured to determine an index value based on one or more parameters of the input prompt 102, such as based on a hash value of the one or more parameters of the input prompt 102, and select the associated machine learning model for processing the input prompt 102.

FIG. 1C illustrates an example machine learning model system 110c similar to machine learning model system 110b. For example, the machine learning model system 110c may provide an input prompt 102 to the configured machine learning model 106c, which is configured to provide an output response 112 in response to the input prompt 102. However, in certain aspects, instead of weight selector 104c being configured to select the machine learning model 106c associated with the selected set of weights from among a plurality of machine learning models as in FIG. 1B, weight selector 104c is configured to select a portion of a machine learning model (referred to as an adaptor) associated with the selected set of weights. The selected adaptor 120 may be combined with a backbone machine learning model 122 that forms the remaining portion of the machine learning model, to form the configured machine learning model 106c.

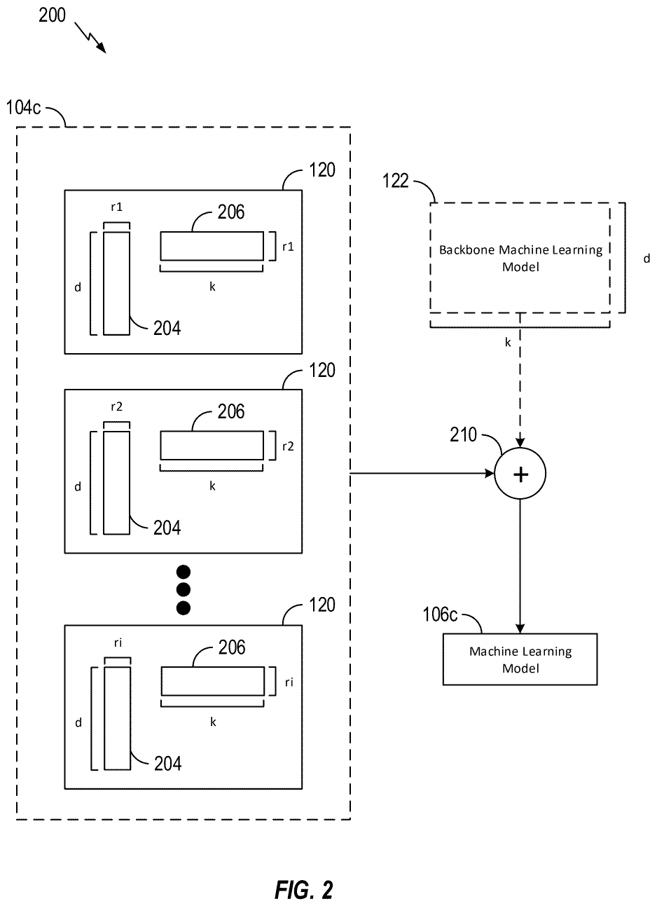

In particular, each of the plurality of adaptors 120 may be associated with a respective set of weights of the plurality of sets of weights, such as corresponding to different trained adaptors for the machine learning model, such as discussed with respect to FIG. 2. The weights of the backbone machine learning model 122 may remain the same.

In certain aspects, weight selector 104c is configured to select the set of weights based on one or more parameters of input prompt 102, such as described with respect to FIG. 1A. Further, weight selector 104c may be configured to map the selected set of weights to an adaptor 120, and combine the adaptor 120 associated with the selected set of weights with backbone machine learning model 122 to form machine learning model 106c.

In certain aspects, the weight selector 104c is configured to map one or more parameters of the input prompt 102 to an adaptor of the plurality of adaptors 120. As an example, each of the plurality of adaptors 120 associated with the plurality of sets of weights may be associated with an index value, such as a first adaptor associated with index 1, a second adaptor associated with index 2, etc. The weight selector 104c may further be configured to determine an index value based on one or more parameters of the input prompt 102, such as based on a hash value of the one or more parameters of the input prompt 102, and select the associated adaptor 120 to combine with backbone machine learning model 122 to form machine learning model 106c for processing the input prompt 102.

In certain aspects, adaptors may be smaller in size than full machine learning models, such that it may be more storage efficient to store adaptors for selection as in FIG. 1C as compared to storing full machine learning models as in FIG. 1B. For example, in certain aspects, using matrix mathematical properties and the process described in more detail in FIG. 2, multiple adaptors 120 may be created that are similar to the machine learning models 108 in FIG. 1B.

In certain aspects, the machine learning model system 110 may be configured to determine whether the input prompt 102 for the machine learning model system 110 poses a potential security risk. For example, the machine learning model system 110 may determine whether the input prompt 102 satisfies a pattern (e.g., is among a large number of prompts within a time window from a same source, is a same prompt as a previous prompt, etc.) and determine that such pattern may identify a potential security risk. In certain aspects, the machine learning model system 110 is configured to select a set of weights only when the machine learning model system 110 determines the input prompt 102 poses a potential security risk. Otherwise, the machine learning model system 110 may be configured to utilize a default set of weights. This may provide the technical benefit of reduced computational complexity for selecting weights only when a security risk is posed.

### Example System for Selecting Machine Learning Model Adaptors

FIG. 2 depicts an example system 200 for selecting an adaptor to form a machine learning model.

As mentioned above, such as with respect to FIGS. 1A-1C, the machine learning model 106 may comprise a multitude of parameters, such as weights that may be trained. Further, as discussed with respect to FIG. 1C, different adaptors 120 may be trained to have different weights, which when combined with a backbone machine learning model 122, form different machine learning models 106c.

For example, in certain aspects, a streamlined and optimized training process, e.g., LoRA, may be used, where separate adaptors 120 may be generated by training a smaller piece of a machine learning model. Each adaptor 120 may be only a fraction of the size of the machine learning model, as opposed to the machine learning models 108 shown in FIG. 1B.

As shown in FIG. 2, an optimized training process such as LoRA may be used to generate adaptors. In this optimized training process, most of the weights of the machine learning model may be frozen and only a subset of weights may be identified and adjusted. The weights of a machine learning model, e.g., machine learning model system 110c, may be expressed as a “weight matrix” comprising a number of rows and a number of columns, where a size is expressed as “number of rows by number of columns.” Matrix mathematical operations may be used to separate such a weight matrix into two component matrices, one matrix representing a set of weights that may be frozen, shown in FIG. 2 as backbone machine learning model 122, and a second matrix representing the parameters that may be identified for adjustment in the optimized training process, shown in FIG. 2 as adaptors 120. Also shown in FIG. 2, an adaptor 120 may be further broken down into matrices 204, 206 that may be smaller than adaptor 120 or backbone machine learning model 122.

In the example of FIG. 2, the weight matrix for machine learning model system 110c may have a size d by k. Therefore, backbone machine learning model 122 may also be sized as d by k and kept unchanged during the optimized training process. Adaptor 120 would also be the same size, d by k, in order to add the two matrices at the end of the process, as shown in FIG. 2 as 210. The weight selector 104c shown in FIG. 2 may introduce a new parameter r, or rank, in creating the two smaller matrices 204, 206, where 204 is sized as d by r and 206 is sized as r by k. The rank r may be selected by the weight selector 104c as the minimum size needed to capture enough distinct parameters in the optimized training process, and it should be noted that a smaller r value means fewer parameters and faster training times, but if r were set too low, model performance may be compromised.

In the example of FIG. 2, multiple values of r, e.g., r1, r2, . . . , ri, may be selected to generate a set of adaptors 120 that may be different from one another, such that each adaptor 120 may comprise different weights, and thus machine learning model parameters, that may be combined with the backbone machine learning model 122 to produce different machine learning models 106c. To complete the training of each adaptor 120, the two smaller matrices 204, 206 may be multiplied together to recover adaptor 120, which as mentioned above is a weight matrix of size d by k, which matches the size as backbone machine learning model 122, the frozen parameter weights mentioned above. Because these matrices are the same size, each of the recovered adaptors 120 may be added individually to the backbone machine learning model 122 to form machine learning models 106c, shown in FIG. 2 as operation 210. The specific adaptor 120 that may be added to the backbone machine learning model 122, and thus the specific machine learning model 106c to be used by machine learning model system 110c, may be selected by weight selector 104c, using the method described above with respect to FIG. 1C.

### Example Method for Varying Machine Learning Model Input

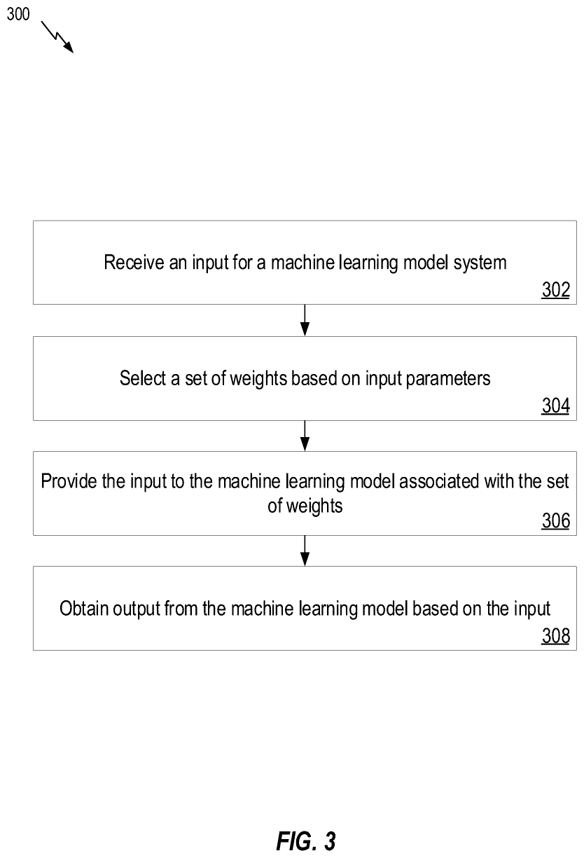

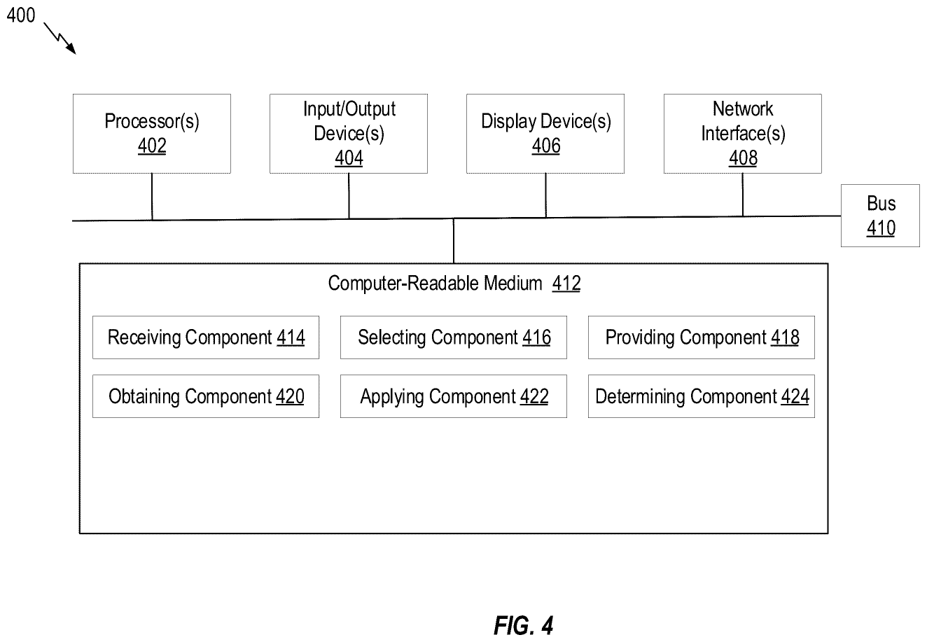

FIG. 3 shows a method 300 for varying machine learning model output. In one aspect, method 300 can be performed by processing system, such as processing system 400 of FIG. 4.

Method 300 begins at block 302 with receiving an input for a machine learning model system.

Method 300 then proceeds to block 304 with selecting, based on one or more parameters associated with the input, a set of weights of a plurality of sets of weights.

Method 300 then proceeds to block 306 with providing the input to a machine learning model associated with the set of weights.

Method 300 then proceeds to block 308 with obtaining output from the machine learning model based on the input.

In some aspects, the one or more parameters of the input for the machine learning model system comprise one or more of: a time at which the input is received, an IP address associated with a source of the input, or an identifier of the source.

In some aspects, the selecting the set of weights comprises applying a hash function to a function of the one or more parameters to generate a hash output; and selecting the set of weights based on the hash output.

In some aspects, the machine learning model system comprises a plurality of trained machine learning models including the machine learning model, each of the plurality of trained machine learning models associated with a respective set of weights of the plurality of sets of weights.

In some aspects, the machine learning model system comprises a plurality of adaptors, each of the plurality of adaptors associated with a respective set of weights of the plurality of sets of weights; the machine learning model system comprises a backbone machine learning model; and the machine learning model comprises an adaptor, of the plurality of adaptors, associated with the set of weights, and the backbone machine learning model.

In some aspects, the adaptor comprises a LoRA.

In some aspects, the machine learning model comprises a large language model.

In some aspects, method 300 further includes determining that the input for the machine learning model system poses a potential security risk, wherein the selecting the set of weights is in response to the determination of the potential security risk.

In some aspects, method 300 further includes receiving a second input for the machine learning model system.

In some aspects, method 300 further includes selecting, based on one or more second parameters associated with the second input, a second set of weights of the plurality of sets of weights.

In some aspects, method 300 further includes providing the second input to a second machine learning model associated with the second set of weights.

In some aspects, method 300 further includes obtaining second output from the second machine learning model based on the second input.

In some aspects, the first input is the same as the second input, the one or more first parameters are different than the one or more second parameters, and the first output is different than the second output.

In some aspect, method 300, or any aspect related to it, may be performed by an apparatus or processing system, such as processing system 400 of FIG. 4, which includes various components operable, configured, or adapted to perform the method 300. Processing system 400 is described below in further detail.

Note that FIG. 3 is just one example of a method, and other methods including fewer, additional, or alternative operations are possible consistent with this disclosure.

### Example Processing System for Varying Machine Learning Model Input

FIG. 4 depicts an example processing system 400 configured to perform various aspects described herein, including, for example, method 300 as described above with respect to FIG. 3.

Processing system 400 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 400 includes one or more processors 402, one or more input/output devices 404, one or more display devices 406, one or more network interfaces 408 through which processing system 400 is connected to one or more networks (e.g., a local network, an intranet, the Internet, or any other group of processing systems communicatively connected to each other), and computer-readable medium 412. In the depicted example, the aforementioned components are coupled by a bus 410, which may generally be configured for data exchange amongst the components. Bus 410 may be representative of multiple buses, while only one is depicted for simplicity.

Processor(s) 402 are generally configured to retrieve and execute instructions stored in one or more memories, including local memories like computer-readable medium 412, as well as remote memories and data stores. Similarly, processor(s) 402 are configured to store application data residing in local memories like the computer-readable medium 412, as well as remote memories and data stores. More generally, bus 410 is configured to transmit programming instructions and application data among the processor(s) 402, display device(s) 406, network interface(s) 408, and/or computer-readable medium 412. In certain embodiments, processor(s) 402 are representative of a one or more central processing units (CPUs), graphics processing unit (GPUs), tensor processing unit (TPUs), accelerators, and other processing devices.

Input/output device(s) 404 may include any device, mechanism, system, interactive display, and/or various other hardware and software components for communicating information between processing system 400 and a user of processing system 400. For example, input/output device(s) 404 may include input hardware, such as a keyboard, touch screen, button, microphone, speaker, and/or other device for receiving inputs from the user and sending outputs to the user.

Display device(s) 406 may generally include any sort of device configured to display data, information, graphics, user interface elements, and the like to a user. For example, display device(s) 406 may include internal and external displays such as an internal display of a tablet computer or an external display for a server computer or a projector. Display device(s) 406 may further include displays for devices, such as augmented, virtual, and/or extended reality devices. In various embodiments, display device(s) 416 may be configured to display a graphical user interface.

Network interface(s) 408 provide processing system 400 with access to external networks and thereby to external processing systems. Network interface(s) 408 can generally be any hardware and/or software capable of transmitting and/or receiving data via a wired or wireless network connection. Accordingly, network interface(s) 408 can include a communication transceiver for sending and/or receiving any wired and/or wireless communication.

Computer-readable medium 412 may be a volatile memory, such as a random access memory (RAM), or a nonvolatile memory, such as nonvolatile random access memory (NVRAM), or the like. In this example, computer-readable medium 412 includes receiving component 414, selecting component 416, providing component 418, obtaining component 420, applying component 422, and determining component 424. Processing of the components 414-424 may enable and cause the processing system 400 to perform the method 300 described with respect to FIG. 3, or any aspect related to it

In certain embodiments, receiving component 414 is configured to receive an input for a machine learning model system, as described in FIG. 3 with reference to block 302.

In certain embodiments, selecting component 416 is configured to select, based on one or more parameters associated with the input, a set of weights of a plurality of sets of weights, as described in FIG. 3 with reference to block 304.

In certain embodiments, providing component 418 is configured to provide the input to a machine learning model associated with the set of weights, as described in FIG. 3 with reference to block 306.

In certain embodiments, obtaining component 420 is configured to obtain output from the machine learning model based on the input, as described in FIG. 3 with reference to block 308.

Note that FIG. 4 is just one example of a processing system consistent with aspects described herein, and other processing systems having additional, alternative, or fewer components are possible consistent with this disclosure.

### Example Clauses

Implementation examples are described in the following numbered clauses:

Clause 1: A computer-implemented method for varying machine learning model output, the method comprising: receiving an input for a machine learning model system; selecting, based on one or more parameters associated with the input, a set of weights of a plurality of sets of weights; providing the input to a machine learning model associated with the set of weights; and obtaining output from the machine learning model based on the input.

Clause 2: The method of Clause 1, wherein the one or more parameters of the input for the machine learning model system comprise one or more of: a time at which the input is received, an IP address associated with a source of the input, or an identifier of the source.

Clause 3: The method of any one of Clauses 1-2, wherein the selecting the set of weights comprises: applying a hash function to a function of the one or more parameters to generate a hash output; and selecting the set of weights based on the hash output.

Clause 4: The method of any one of Clauses 1-3, wherein the machine learning model system comprises a plurality of trained machine learning models including the machine learning model, each of the plurality of trained machine learning models associated with a respective set of weights of the plurality of sets of weights.

Clause 5: The method of any one of Clauses 1-3, wherein: the machine learning model system comprises a plurality of adaptors, each of the plurality of adaptors associated with a respective set of weights of the plurality of sets of weights; the machine learning model system comprises a backbone machine learning model; and the machine learning model comprises an adaptor, of the plurality of adaptors, associated with the set of weights, and the backbone machine learning model.

Clause 6: The method of Clause 5, wherein the adaptor comprises a LoRA.

Clause 7: The method of any one of Clauses 1-6, wherein the machine learning model comprises a large language model.

Clause 8: The method of any one of Clauses 1-7, further comprising: determining that the input for the machine learning model system poses a potential security risk, wherein the selecting the set of weights is in response to the determination of the potential security risk.

Clause 9: The method of any one of Clauses 1-8, further comprising: receiving a second input for the machine learning model system; selecting, based on one or more second parameters associated with the second input, a second set of weights of the plurality of sets of weights; providing the second input to a second machine learning model associated with the second set of weights; and obtaining second output from the second machine learning model based on the second input.

Clause 10: The method of Clause 9, wherein the first input is the same as the second input, the one or more first parameters are different than the one or more second parameters, and the first output is different than the second output.

Clause 11: A processing system, comprising: memory comprising computer-executable instructions; and one or more processors configured to execute the computer-executable instructions and cause the processing system to perform a method in accordance with any one of Clauses 1-10.

Clause 12: A processing system, comprising means for performing a method in accordance with any one of Clauses 1-10.

Clause 13: A non-transitory computer-readable medium storing program code for causing a processing system to perform the steps of any one of Clauses 1-10.

Clause 14: A computer program product embodied on a computer-readable storage medium comprising code for performing a method in accordance with any one of Clauses 1-10.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for varying machine learning model output, the method comprising:
receiving an input for a machine learning model system;
selecting, based on one or more parameters associated with the input, a set of weights of a plurality of sets of weights;
providing the input to a machine learning model associated with the set of weights; and
obtaining output from the machine learning model based on the input.

2. The method of claim 1, wherein the one or more parameters of the input for the machine learning model system comprise one or more of: a time at which the input is received, an Internet protocol (IP) address associated with a source of the input, or an identifier of the source.

3. The method of claim 1, wherein the selecting the set of weights comprises:
applying a hash function to a function of the one or more parameters to generate a hash output; and
selecting the set of weights based on the hash output.

4. The method of claim 1, wherein the machine learning model system comprises a plurality of trained machine learning models including the machine learning model, each of the plurality of trained machine learning models associated with a respective set of weights of the plurality of sets of weights.

5. The method of claim 1, wherein:
the machine learning model system comprises a plurality of adaptors, each of the plurality of adaptors associated with a respective set of weights of the plurality of sets of weights;
the machine learning model system comprises a backbone machine learning model; and
the machine learning model comprises an adaptor, of the plurality of adaptors, associated with the set of weights, and the backbone machine learning model.

6. The method of claim 5, wherein the adaptor comprises a low-rank adaptor (LoRA).

7. The method of claim 1, wherein the machine learning model comprises a large language model.

8. The method of claim 1, further comprising:
determining that the input for the machine learning model system poses a potential security risk, wherein the selecting the set of weights is in response to the determination of the potential security risk.

9. The method of claim 1, further comprising:
receiving a second input for the machine learning model system;
selecting, based on one or more second parameters associated with the second input, a second set of weights of the plurality of sets of weights;
providing the second input to a second machine learning model associated with the second set of weights; and
obtaining second output from the second machine learning model based on the second input.

10. The method of claim 9, wherein the first input is the same as the second input, the one or more first parameters are different than the one or more second parameters, and the first output is different than the second output.

11. A processing system, comprising: memory comprising computer-executable instructions; and one or more processors configured to execute the computer-executable instructions and cause the processing system to:
receive an input for a machine learning model system;
select, based on one or more parameters associated with the input, a set of weights of a plurality of sets of weights;
provide the input to a machine learning model associated with the set of weights; and
obtain output from the machine learning model based on the input.

12. The processing system of claim 11, wherein the one or more parameters of the input for the machine learning model system comprise one or more of: a time at which the input is received, an Internet protocol (IP) address associated with a source of the input, or an identifier of the source.

13. The processing system of claim 11, wherein to cause the processing system to select the set of weights, the one or more processors are configured to execute the computer-executable instructions and cause the processing system to apply a hash function to a function of the one or more parameters to generate a hash output; and selecting the set of weights based on the hash output.

14. The processing system of claim 11, wherein the machine learning model system comprises a plurality of trained machine learning models including the machine learning model, each of the plurality of trained machine learning models associated with a respective set of weights of the plurality of sets of weights.

15. The processing system of claim 11, wherein the machine learning model system comprises a plurality of adaptors, each of the plurality of adaptors associated with a respective set of weights of the plurality of sets of weights; the machine learning model system comprises a backbone machine learning model; and the machine learning model comprises an adaptor, of the plurality of adaptors, associated with the set of weights, and the backbone machine learning model.

16. The processing system of claim 15, wherein the adaptor comprises a low-rank adaptor (LoRA).

17. The processing system of claim 11, wherein the machine learning model comprises a large language model.

18. The processing system of claim 11, wherein the one or more processors are configured to execute the computer-executable instructions and cause the processing system to:
determine that the input for the machine learning model system poses a potential security risk, wherein the selecting the set of weights is in response to the determination of the potential security risk.

19. The processing system of claim 11, wherein the one or more processors are configured to execute the computer-executable instructions and cause the processing system to:
receive a second input for the machine learning model system;
select, based on one or more second parameters associated with the second input, a second set of weights of the plurality of sets of weights;
provide the second input to a second machine learning model associated with the second set of weights; and
obtain second output from the second machine learning model based on the second input.

20. One or more non-transitory computer-readable media comprising executable instructions that, when executed by one or more processors of an apparatus, cause the apparatus to perform operations comprising:
receiving an input for a machine learning model system;
selecting, based on one or more parameters associated with the input, a set of weights of a plurality of sets of weights;
providing the input to a machine learning model associated with the set of weights; and
obtaining output from the machine learning model based on the input.
